(19) United States
(12) Patent Application Publication
(10) Pub. No.: US 2007/0197694 A1
(43) Pub. Date: Aug. 23, 2007

(54) CONTROLLED SHRINKAGE ULTRAVIOLET LIGHT RESISTANT MOLDING COMPOUND

(76) Inventors: Probir K. Guha, Troy, MI (US); Michael J. Siwajek, Rochester Hills, MI (US); Brian A. Beach, Detroit, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/675,911

(22) Filed: Feb. 16, 2007

Related U.S. Application Data
(60) Provisional application No. 60/774,577, filed on Feb. 17, 2006.

(51) Int. Cl. C08K 5/34

(52) U.S. Cl. 524/106

(57) ABSTRACT

A molding composition formulation is provided that includes a thermoset cross-linkable polymeric resin and an ultraviolet light absorber. A shrinkage-reducing polymeric additive is present in the formulation from between 3 and 30 total weight percent, such that upon cure a linear shrinkage rate of within ±1.0% is obtained. Shrinkage-reducing polymeric additives include a condensation polyester of glycol and a polyacid or acid anhydride, polyvinyl acetate, polymethylmethacrylate, or polyether polyol. A vehicle body component formed through a sheet molding composition formulation is provided as recited above, and includes a fiberglass filler. A process for producing a vehicle body component exposed to ultraviolet light upon environmental exposure of a vehicle includes molding at an elevated temperature above 20° C. the vehicle component from the formulation as detailed above. The process is followed by trimming the molded vehicle component prior to assembly.

### CROSS-REFERENCE TO RELATED APPLICATIONS

This application claims priority of U.S. Provisional Patent Application Ser. No. 60/774,577 filed Feb. 17, 2006, which is incorporated herein by reference.

### FIELD OF THE INVENTION

The present invention in general relates to SMC (Sheet Molding Compound) formulations and in particular to SMC resistant to ultraviolet light degradation that is moldable with dimensional stability.

### BACKGROUND OF THE INVENTION

Vehicle body components are exposed to temperature extremes, corrosion associated with road salt and acid rain, as well as ultraviolet light exposure. Traditionally, vehicle body components have been formed of sheet metal even though this material is prone to corrosion in the event that protective paints and coatings become damaged. Sheet molding compound formed vehicle body components represent an attractive alternative since these materials are corrosion resistant, dent resistant, and often provide weight advantages. However, owing to the occurrence of unsaturated bonds within a molded sheet molding compound, these materials are susceptible to environmental degradation associated with ultraviolet light exposure and ozone exposure. While additive packages have been developed to render sheet molding compound resistant to ultraviolet light and ozone degradation, the resulting compositions have met with limited acceptance owing to excessive shrinkage of components molded from such formulations, Inconsistency in dimensional properties associated with shrinkage detracts from vehicle finish and manufacturability.

Thus, there exists a need for a molding compound inclusive of an ultraviolet light degradation resistance package that retains dimensional stability of an article molded therefrom. Vehicle body components in general, and pickup boxes in particular, benefit from the existence of such a formulation.

### SUMMARY OF THE INVENTION

A molding composition formulation is provided that includes a thermoset cross-linkable polymeric resin. An ultraviolet light absorber is also provided. A shrinkage-reducing polymeric additive is present in the formulation from between 3 and 30 total weight percent, such that the formulation upon cure retains a linear based shrinkage rate of within ±1.0%. Shrinkage-reducing polymeric additives include a condensation polyester of glycol and a polyacid, a condensation polyester of glycol and an acid anhydride, saturated polyester, polyvinyl acetate, polyether polyol, copolymers of any of the aforementioned or mixtures thereof. Ideally, the formulation is exclusive of additional substances rendering the formulation.

A vehicle body component formed through a sheet molding composition formulation is provided and includes a thermoset polymeric resin cured into a form of the vehicle body component and having a linear based shrinkage of within ±1.0%. The thermoset polymeric resin contains mixed therethrough an ultraviolet light absorber, a shrinkage-reducing polymeric additive, as recited above, and a fiberglass filler.

A process for producing a vehicle body component exposed to ultraviolet light upon environmental exposure of a vehicle includes molding at an elevated temperature above 20° C. the vehicle component from the formulation as detailed above. The process is followed by trimming the molded vehicle component prior to assembly.

### DETAILED DESCRIPTION OF THE PREFERRED EMBODIMENTS

The present invention has utility as a molding compound resistant to ultraviolet (UV) degradation while maintaining a linear paste shrinkage of the article within ±1.0%. While conventional UV-resistant additive packages are effective in maintaining a sheet or bulk molding compound formed article from UV exposure, the chemical shrinkage has previously proved unacceptable. The present invention provides a molding compound formulation that has the UV protective attributes while restoring a dimensional stability suitable for production.

As used herein “total weight percent” is intended to define a fully loaded molding composition inclusive of fillers and fibers.

As used herein “organic matrix weight percent” is intended to define a molding composition exclusive of fillers and fibers.

An inventive SMC formulation affords UV resistance and a linear paste shrinkage of within ±1.0% with linear paste shrinkage being measured for a resin matrix formulation lacking fiber filler and relates to a flat panel mold and the comparative length of an article formed from the mold. Optionally, low profile additives are provided to enhance surface finish properties. Typical and preferred ranges of inventive SMC formulations are provided in Table 1.

TABLE 1
Components as Percentages of Fully
Formulated Inventive Molding Composition

| | Typical Total | Preferred Total |
|---|---|---|
| | Weight Percent | Weight Percent |
| Reactants | | |
| Cross-linkable polymer (unsaturated | 6–50 | 8–20 |
| polyester and/or vinyl ester resins) | | |
| Ethylenically unsaturated monomer | 4–50 | 6–21 |
| (e.g. styrene) | | |
| Reaction Kinetic Modifiers | | |
| Free radical initiation (e.g. peroxide/ | 0–3 | 0.1–1 |
| peroxy ketals, or azo cmpds) | | |
| Polymerization inhibitor (e.g. | 0–2 | 0.1–1 |
| hydroquinone) | | |
| Additives | | |
| Mold release (e.g. stearate additive) | 0–5 | 0.2–1 |
| Low profile (polyester) | 0–20 | 3–15 |
| Plasticizer | 0–3 | 0.1–0.5 |
| Flame retardant | 0–3 | 0.1–0.7 |
| Thickeners | 0–5 | 0.5–2.5 |
| Colorants | 0–3 | 0.1–1 |
| Fillers | | |
| Particulate filler (e.g. calcium carbonate | 0–80 | 15–50 |
| or alumina) | | |
| Fiber fillers (e.g. glass) | 0–80 | 5–60 |
| UV Degradation Inhibitor | 0.2–10 | 1–6 |
| Shrinkage Reducing Additives | | |
| Total amount | 3–30 | 4–14 |
| Including at least one of: | | |
| A condensation polyester of a glycol | 0–20 | 3–10 |
| and a polyacid or polyacid anhydride | | |
| Polyvinyl acetate or | 0–20 | 1–4 |
| Copolymers of polyvinyl acetate | 0–20 | 0–10 |

A principal component of an SMC formulation is a cross-linkable polymer resin such as an unsaturated polyester resin or vinyl ester resin. The prepolymer polymeric resin has a molecular weight on average of typically between 200 and 50,000 Daltons. The polyester prepolymer resins typically represent condensation products derived from the condensation of unsaturated dibasic acids and/or anhydrides with polyols. It is appreciated that the saturated di- or poly-acids are also part of the condensation process to form polyester prepolymers with a lesser equivalency of reactive ethylenic unsaturation sites. Polymeric resins particularly well suited for vehicle components include isophthalic unsaturated polyester, propylene glycol maleic anhydride, neopentyl propylene glycol maleic anhydride, and combinations thereof.

Vinyl ester resins are also typically employed in SMC formulations as a polymeric resin. Vinyl ester prepolymer resins are typically the reaction product of an epoxy resin with a carboxylic acid having a single ethylenic unsaturation. Specific vinyl ester resins commonly used are the reaction product of epoxy functionalized bisphenol A with an acrylic acid and polymethylmethacrylate. As a result of the difference in prepolymer synthesis, the vinyl ester resin prepolymers are typically associated with terminal ethylenic unsaturations while polyester resin prepolymers predominantly have ethylenic unsaturations internal to the prepolymer backbone.

The polymeric resin prepolymer is suspended, and preferably dissolved, in an ethylenically unsaturated monomer that copolymerizes with the resin during the thermoset process. Representative monomers illustratively styrene, vinyl toluene, N-vinylpyrrolidone, divinyl benzene, acrylic acid esters and methacrylic acid esters, such as methylacrylate, ethylacrylate, n-butylacrylate, 2-ethylhexylacrylate, methylmethacrylate, pentaerythritol thiacrylate, ethyleneglycol dimethacrylate, diallyl maleate, diallyl fumarate, triallycyanurate, vinyl acetate, vinyl propionate, vinyl ether, acrylonitrile, and the like. It is appreciated that more than one type of monomer can be used in a molding composition. The monomer provides benefits including lower prepolymer viscosity and thermosetting without formation of a volatile byproduct.

A typical molding composition includes a free radical initiator to initiate cross-linking between the polymeric prepolymer resin with itself or with ethylenically unsaturated monomer, if present. A free radical initiator is typically chosen to preclude significant cross-linking at lower temperature so as to control the thermoset conditions. Conventional free radical polymerization initiators contain either a peroxide or azo group. Peroxides operative herein illustratively include benzoyl peroxide, cyclohexanone peroxide, ditertiary butyl peroxide, dicumyl peroxide, tertiary butyl perbenzoate and 1,1-bis(t-butyl peroxy) 3,3,5-trimethylcyclohexane. Azo species operative herein illustratively include azobisisobutyronitrile and t-butylazoisobutyronitrile. While the quantity of free radical polymerization initiator present varies with factors such as desired thermoset temperature and decomposition thermodynamics, an initiator is typically present from 0 to 3 total weight percent.

In order to lessen cross-linking at temperatures below the desired thermoset temperature, a polymerization inhibitor is often included in base molding formulations. Hydroquinone and t-butyl catechol are conventional inhibitors. An inhibitor is typically present between 0 and 2 total weight percent.

The molding composition preferably includes a particulate filler. Particulate fillers operative in such molding compositions illustratively include calcium carbonate, calcium silicate, alumina, silica, talcs, dolomite, vermiculite, diatomaceous earth, glass spheres, graphite, metal and combinations thereof. Factors relevant in the choice of a particulate filler illustratively include filler cost, resultant viscosity of flow properties, resultant shrinkage, surface finish weight, flammability, electrical conductivity, and chemical resistance of the thermoset formulation. Particulate filler typically accounts from 0 to 80 weight percent. Typical filler sizes are from 0.1 to 50 microns.

A fiber filler is typically added to provide strength relative to a particulate filler. Fiber fillers operative herein illustratively include glass, carbon, polyimides, polyesters, polyamides, and natural fibers such as cotton, silk, and hemp. Preferably, the fiber filler is glass fiber in the form of chopped glass strands. Fiber fillers are typically present from 0 to 80 total weight percent.

A mold release agent is typically provided to promote mold release. Mold releases include fatty acids and salts illustratively including oleates, palmitates, sterates of metal ions such as sodium, zinc, calcium, magnesium, and lithium. A mold release is typically present from 0.1 to 5 total weight percent.

A low profile additive is also optionally present to improve surface finish properties. Such additives include a variety of thermoplastics and elastomers. Low profile additives are typically present from 0 to 15 total weight percent and more often from 1 to 12 total weight percent of the SMC, with the nature of additive and the resulting linear shrinkage dictating the amount. Saturated polyalkylenes represent low profile additives particularly well suited for UV exposure.

It is appreciated that the present invention optionally also incorporates additional additives illustratively including plasticizers, flame retardants, thickeners, colorants, and other processing additives conventional to the art.

An ultraviolet light degradation inhibitor is provided to impart stability to a cured article formed of an inventive molding compound that is exposed to ambient light and atmospheric free radicals. The measure of environmental degradation is referred to as weatherability and determined based on gloss retention. Standard weatherability testing procedures are established and include SAE J1960, ASTM D570, ASTM D638, ASTM D790, ASTM D792, ASTM D2584 and ASTM D4812. Weatherability requirements for components include 1500 kJ/m2 exposure per SAE J1960 resulting in a ΔE of less than 3 and a gloss retention greater than 70%. The mechanisms and chemistry of polyester photolysis and photo oxidation are well known. Day et al., Journal of Applied Polymer Science 1972, 16:175-215.

Strategies for inhibiting polyester photolysis operative herein include eliminating aromatic acids from the prepolymer so as to preclude formation of a stable leaving group reaction byproduct, and the inclusion of ultraviolet light absorbers. Preferably both strategies are employed in an inventive formulation. Ultraviolet light absorbing compounds function to absorb ultraviolet radiation and in the process inhibit the formation of free radicals. Suitable ultraviolet light absorbers operative herein illustratively include benzotriazoles such as 6-tert-butyl-2-(5-chloro-2H-benzotriazole-2-yl)-4-methylphenol, 2,4-di-tert-butyl-6-(5-chloro-2H-benzotriazole-2-yl)-phenol, 2-(2H-benzotriazole-2-yl)-4,6-di-tert-pentylphenol, 2-(2H-benzotriazole-2-yl)-4-(1,1,3,3-tetramethylbutyl)-phenol, 2-(2H-benzotriazole-2-yl)-4-methylphenol, 2-(2H-benzotriazole-2-yl)-4,6-bis(1-methyl-1-phenylethyl)phenol and 2-(3-tert-butyl-2-hydroxy-5-methylphenyl)-5-chloro-2H-benzotriazole; tolutriazoles; benzophenones such as dihalo benzophenones where the halogens in each instance are independently chlorine or fluorine, dihydroxybenzophenones, dihydroxy diacryloxybenzophenones, dihydroxy dimethoxybenzophenones, dihydroxy methoxybenzophenones, dihydroxyxanthones, dimethoxybenzophenones, dimethoxyxanthones, di-C₁-C₄ benzothiazoles, fluorobenzophenones, fluorohydrogenated benzophenones, fluoro hydroxy alkoxy benzophenones, fluoro C₁-C₄ alkoxybenzophenones, hydroxy acryloxybenzophenones, hydrogenated benzophenones, trifluorobenzophenones, trihydroxybenzophenones, and tri-C₁-C₄ alkoxybenzophenones; sterically hindered amines such as those having CAS numbers 152261-33-1, 65447-77-0, 41556-26-7, 82919-37-7, 52829-07-9 and 124172-53-8, as well as other tetra alkyl piperidine containing species; triazines such as 2-N-octylthio-4,6-di(4′-hydroxy-3-5′-di-t-butyl) phenoxy-1,3,5-triazine; tolyltriazoles; cyanoacrylates such as (2-ethylhexyl)-2-cyano-3,3-diphenyl acrylate and ethyl-2-cyano-3,3-diphenyl acrylate; carbon black; and mixed metal oxides particulate of the formula M^{a}ₓM^{z}_{y}O_{(ax+zy)/2}, where Ma is a transition metal of a Group other than VIII having an oxidation state +a, x is a rational value greater than zero and less than 4, M^{z} is a transition metal of exclusive of Fe, Co, Ru, Rh, Pd, Os, Ir, and Pt that has an oxidation state +z, and, y is a rational value greater than zero and less than 4 so x+y is equal to or greater than 2. CuCr₂O₄ is exemplary of such a mixed metal oxide. The UV light absorber package of one or more absorbers is typically present from 0.2 to 10 total weight percent with the proviso that carbon black if present is preferably present from 2 to 3 total weight percent. Preferably, the UV light absorber package is present from 1 to 5 organic matrix weight percent and more preferably from 1 to 3 organic matrix weight percent. It is appreciated that these various UV absorbers have different light absorption spectra and modes of action such as UV light absorption, excited state quenching, and combinations thereof; preferably, the UV degradation inhibitor is a combination of more than one of the above UV light absorbers. It is appreciated that nitrogen-containing UV light absorbers tend to have deleterious effects on molding compound properties and as such are used only with care. Nitrogen containing UV light absorbers in which the nitrogen is present in the form >N—O—R where R is a C₁-C₂₀ alkyl are appreciated to largely overcome the deleterious effects that amines typical have on resin cure characteristics. The combination of a benzophenone and carbon black is particularly advantageous, with carbon black present at between 2 and 3 organic matrix weight percent. Alternatively benzophenone and mixed metal oxide CuCr₂O₄ each present at 2 organic matrix weight percent also is highly effective at UV stabilization. It is appreciated that one or more substituent groups such as C₁-C₂₀ alkyls, hydroxyl groups, C₁-C₂₀ alkoxy, fluoro, chloro and other groups are readily substituted onto a base structure of an organic UV light absorber to enhance processability and miscibility of the UV light absorber in the formulation. Unfortunately, the inclusion of organic UV light absorbers leads to inconsistency in dimensional properties of cured articles as a result of shrinkage.

Molding compositions of the present invention are well suited for the rapid production of molded composite material for the production of a variety of products illustratively including truck bed liners, pickup truck boxes, tonneau covers, tailgate panels, midgate panels, running boards, vehicle spoilers, vehicle hoods, and various industrial and consumer product housings. Fibrous glass reinforcing materials operative in the present invention illustratively include chopped strand, matte, continuous strand, surfacing matte, glass cloth and roving cloth. It is also appreciated that other non-silaceous reinforcing fibrous materials are also operative herein illustratively including natural fibers, aramid fibers, carbon fiber, each alone, or in combination with glass fibers.

A shrinkage-reducing additive is provided to restore article dimensional stability diminished by UV degradation inhibitor inclusion. A shrinkage-reducing additive is preferably UV tolerant and illustratively includes a condensation polyester of a glycol and a polyacid, a condensation polyester of a glycol and a polyacid anhydride; ethylenically saturated polyester; polyvinyl acetate; polyether polyols; or copolymers of any of the aforementioned; or a combination of more than one of the preceding polymers. The condensation of a polyglycol and a polyacid is a well-established chemistry to form a polyester. Secondary glycols are known to produce better ester yields than primary glycols. Polyacids are typically carboxyl terminated diacids illustratively including malonic, succinic, adipic, pimelic, sebacic, maleic, fumaric, citraconic, camphoric, phthalic, and isophthalic; as well as the acid anhydrides succinic, glutaric, maleic, phthalic, and isophthalic that readily hydrolyze to diacids, Preferably, a preformed condensation polyester of a glycol and a polyacid or anhydride thereof is added to an inventive formulation. A polyester of the form

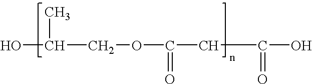

is readily formed through reaction of propylene glycol and maleic anhydride with n varying from 50 to 1000. A condensation polyester having a molecular weight between 10,000 and 50,000 is particularly preferred and commercially available from Ashland Chemical.

Typically, an inventive shrinkage-reducing additive is present as a single polymer, or as a package of polymers is present from 3 to 30 total weight percent with still maintaining a linear paste shrinkage of +1.0%. Preferably, the moisture-reducing additive is a package of polymers present from 4 to 14 total weight percent. For reasons that remain unclear, a shrinkage reducing additive package of a condensation polyester of glycol with a polyacid and polymethylmethacrylate or polyvinyl acetate provides a synergistic effect in maintaining linear paste shrinkage within manufacturing tolerances relative to either polymer alone at comparable loadings. Weight ratios of the condensation polyester of glycol and acid: polymethylmethacrylate or polyvinylacetate are typically 1:02-5.

References recited herein are indicative of the level of skill in the art to which the invention pertains. These references are hereby incorporated by reference to the same extent as if each individual reference was explicitly and individually incorporated herein by reference.

1. A molding composition formulation comprising:
a thermoset cross-linkable polymeric resin;
an ultraviolet light absorber;
a shrinkage-reducing polymeric additive selected from the group consisting of: a condensation polyester of glycol and a polyacid, a condensation polyester of glycol and an acid anhydride, polyvinyl acetate, polymethylmethacrylate, saturated polyester, polyether polyols, copolymers thereof, and a combination thereof said additive being present between 3 and 30 total weight percent such that the formulation upon cure retains a linear paste shrinkage rate of within ±1.0%.

2. The formulation of claim 1 wherein said shrinkage-reducing additive is in combination said condensation polyester of glycol and the polyacid or said condensation polyester of glycol and the acid anhydride and said polymethylmethacrylate.

3. The formulation of claim 2 wherein a weight ratio of said condensation polyester of glycol and a polyacid or said condensation polyester of glycol and the acid anhydride: polymethylmethacrylate acetate is 1:02-5.

4. The formulation of claim 1 wherein said shrinkage-reducing additive is present from 4 to 14 total weight percent.

5. The formulation of claim 1 wherein said UV light degradation inhibitor includes at least one of a benzotriazole, a benzophenone, a sterically hindered amine, carbon black, mixed metal oxides particulate of the formula M×M^{z}_{y}O_{(ax+zy)/2}, where Ma is a transition metal of a Group other than VIII having an oxidation state +a, x is a rational value greater than zero and less than 4, M^{z} is a transition metal of exclusive of Fe, Co, Ru, Rh, Pd, Os, Ir, and Pt that has an oxidation state +z, and, y is a rational value greater than zero and less than 4 so x+y is equal to or greater than 2 with the proviso that if carbon black is present a carbon black amount is from 2 to 3 organic matrix weight percent.

6. The formulation of claim 1 wherein said resin is an unsaturated polyester.

7. The formulation of claim 1 wherein said resin is selected from the group consisting of: propylene glycol maleic anhydride, a neopentyl propylene glycol maleic anhydride, or a combination thereof.

8. The formulation of claim 1 further comprising an ethylenically unsaturated monomer.

9. The formulation of claim 1 further comprising at least one additional substance selected from the group consisting of: a free radical initiator, polymerization inhibitor, particulate filler, fiber filler, a mold release agent, a low profile additive, a plasticizer, a flame retardant, a thickener, and a colorant.

10. The formulation of claim 9 wherein said at least one additional substance is a glass fiber filler.

11. A vehicle body component comprising:
a thermoset polymeric resin cured into a form of the vehicle body component and having a linear paste shrinkage rate of within ±1.0% comprising an ultraviolet light absorber; a shrinkage-reducing polymeric additive selected from the group consisting of: a condensation polyester of glycol and a polyacid, a condensation polyester of a glycol and an acid anhydride, polyvinyl acetate, polymethylmethacrylate, saturated polyester, a polyether polyol, copolymers thereof, and a combination thereof; and a fiberglass filler.

12. The automotive body component of claim 11 wherein the form is a tonneau cover.

13. The automotive body component of claim 11 wherein the form is a truck box.

14. The automotive body component of claim 11 wherein the form is a vehicle panel selected from the group consisting of: tailgate and midgate.

15. The automotive body component of claim 11 wherein the form is a running board.

16. The automotive body component of claim 11 wherein the form is a truck box.

17. A process for producing a vehicle body component exposed to ultraviolet light upon environmental exposure of a vehicle consisting of:
molding at elevated temperature above 20° C. the vehicle component from a formulation of claim 1 and independent of a UV protective coating; and
trimming the molded vehicle component prior to assembly.

18. The process of claim 17 wherein the formulation is a sheet molding composition.
